(19) United States
(12) Patent Application Publication
(10) Pub. No.: US 2013/0337406 A1
(43) Pub. Date: Dec. 19, 2013

(54) SALIVA EJECTOR TIP WITH ON/OFF VACUUM VALVE

(71) Applicant: Anthony Bordas, Downey, CA (US)

(72) Inventor: Anthony Bordas, Downey, CA (US)

(21) Appl. No.: 13/523,151

(22) Filed: Jun. 14, 2012

(51) Int. Cl. A61C 17/06

(52) U.S. Cl. 433/95

(57) ABSTRACT

A system for removing saliva or debris from the mouth of a dental patient. One end of tubing is connected to a vacuum pump. The other end of the tubing is connected to removably connected tip. A vacuum control valve is connected to the removably connected tip. The vacuum control valve is positioned so that the vacuum control valve remains outside of the patient's mouth when the tip is inserted into to patient's mouth. In a preferred embodiment, the vacuum control valve is a push valve and is located approximately half way along the length of the removably connected tip. In one preferred embodiment the tip is a removably connected saliva ejector tip. In another preferred embodiment the tip is a removably connected high-volume evacuator tip. In another preferred embodiment the tip is a removably connected surgical high volume evacuator tip.

The present invention relates to dental systems, and in particular to saliva ejector tips and high volume suction tips.

### BACKGROUND OF THE INVENTION

Saliva ejector systems are known in the prior art. A saliva ejector system includes a narrow, small diameter flexible tube for the purpose of suctioning liquids only. The saliva ejector does not remove particles from the oral cavity. Its purpose is to only remove fluids. The flexible tube is connected via a small diameter hose to a vacuum pump.

FIG. 1 shows a prior art saliva ejector system 10. Metal on/off valve 3 is connected to vacuum pump 4. Flexible tubing 3 is connected to on/off valve 3 and to saliva ejector tip 1.

A dental practitioner operates saliva ejector system 10 by turning on vacuum pump 4 and opening valve 3. Saliva ejector tip 1 is then inserted into the mouth of the patient and saliva is sucked from the patient's mouth, through tubing 2 to pump 4. When the dental practitioner no longer needs vacuum suction, he will shut valve 3. He will then open valve 3 as appropriate to the procedure and the patient.

After each procedure it is very important to ensure that saliva ejector system 10 has been properly sterilized. Saliva ejector tip 1 and tubing 2 can be discarded. However, to replace valve 3 would be impractical and expensive. Therefore, valve 3 must be manually sterilized after each patient. This is a time consuming, cumbersome and expensive process.

High volume evacuators are also known in the prior art. The high volume evacuator includes a non-flexible tube of a large diameter which is attached to a vacuum pump via a large diameter hose. Due to the larger diameter, this suctioning device is able to remove larger particles from the oral cavity. In addition, due to the larger diameter the volume capacity is much greater.

Surgical high-volume evacuators are also known in the prior art. A surgical high-volume evacuator is connected to a vacuum pump via a large diameter hose (the same hose as the high volume evacuator described above). The only difference between this device and the high volume suction evacuator is the tip. The non-flexible tube tapers to a smaller diameter at the tip. This allows the use of high volume suction for procedures that require difficult access (such as surgical and endodontic procedures). It has the same volume capacity, but tapers at the tip to gain access in the oral cavity that require a small device.

What is needed is better device for controlling vacuum suction at the tip of a saliva ejector and high volume suction systems.

### SUMMARY OF THE INVENTION

The present invention provides a system for removing saliva or debris from the mouth of a dental patient. One end of tubing is connected to a vacuum pump. The other end of the tubing is connected to removably connected tip. A vacuum control valve is connected to the removably connected tip. The vacuum control valve is positioned so that the vacuum control valve remains outside of the patient's mouth when the tip is inserted into to patient's mouth. In a preferred embodiment, the vacuum control valve is a push valve and is located approximately half way along the length of the removably connected tip. In one preferred embodiment the tip is a removably connected saliva ejector tip. In another preferred embodiment the tip is a removably connected high-volume evacuator tip. In another preferred embodiment the tip is a removably connected surgical high volume evacuator tip.

### BRIEF DESCRIPTION OF THE DRAWINGS

FIG. 1 shows a prior art saliva ejector system.

FIG. 2 shows an exploded perspective view of a preferred embodiment of the present invention.

FIG. 3 shows a side view of a preferred embodiment of the present invention.

FIG. 4 shows the connection of a preferred push valve.

FIGS. 5-6 show the operation of a preferred embodiment of the present invention.

FIG. 7 shows a preferred system.

FIG. 8 shows another preferred system.

FIG. 9 shows a preferred high volume evacuator tip.

FIG. 10 shows a preferred surgical high volume evacuator tip.

### DETAILED DESCRIPTION OF THE PREFERRED EMBODIMENTS

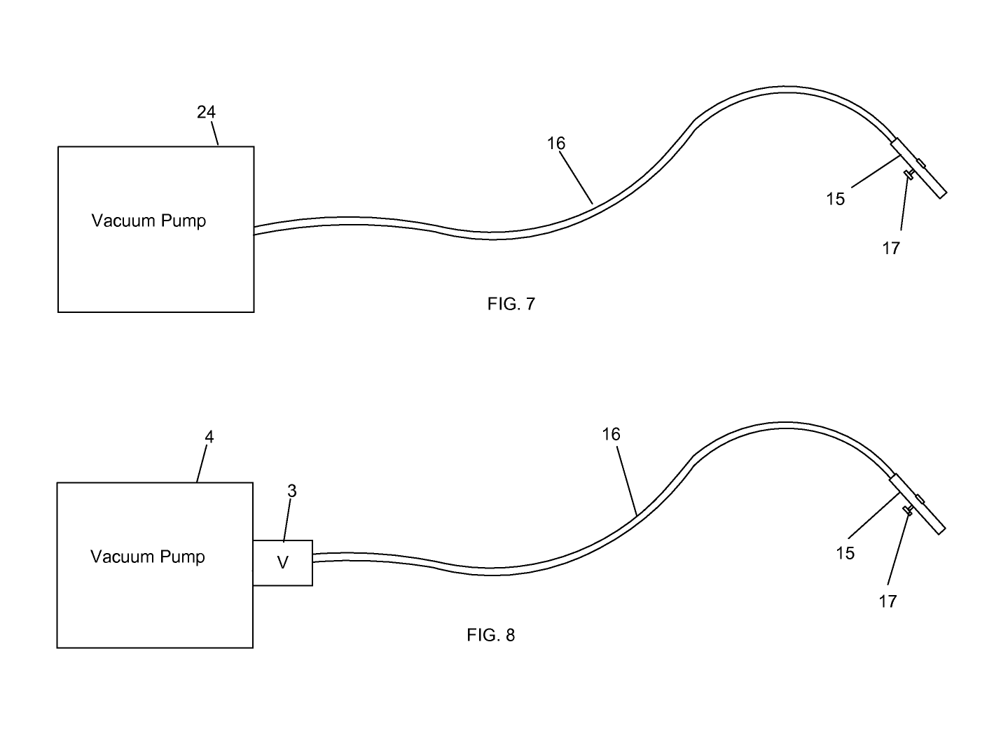

FIG. 7 shows a preferred embodiment of the present invention. Saliva ejector 15 is connected to tubing 16. Tubing 16 is directly connected to vacuum pump 24. On/off vacuum valve 17 is located approximately half way down on saliva ejector 15. In the preferred embodiment shown in FIG. 7 the dental practitioner can turn the vacuum on and off by operating valve 17. After the patient is finished with his treatment the dental practitioner can dispose of saliva ejector 15 and tubing 16. There is no on/off valve connected to pump 4. Therefore, there is no need to sterilize a separate on/off valve. This provides a significant savings in time and cost. The dental practitioner can then add a new saliva ejector 15 with tubing 16 and be ready for the next patient.

### Preferred Saliva Ejector

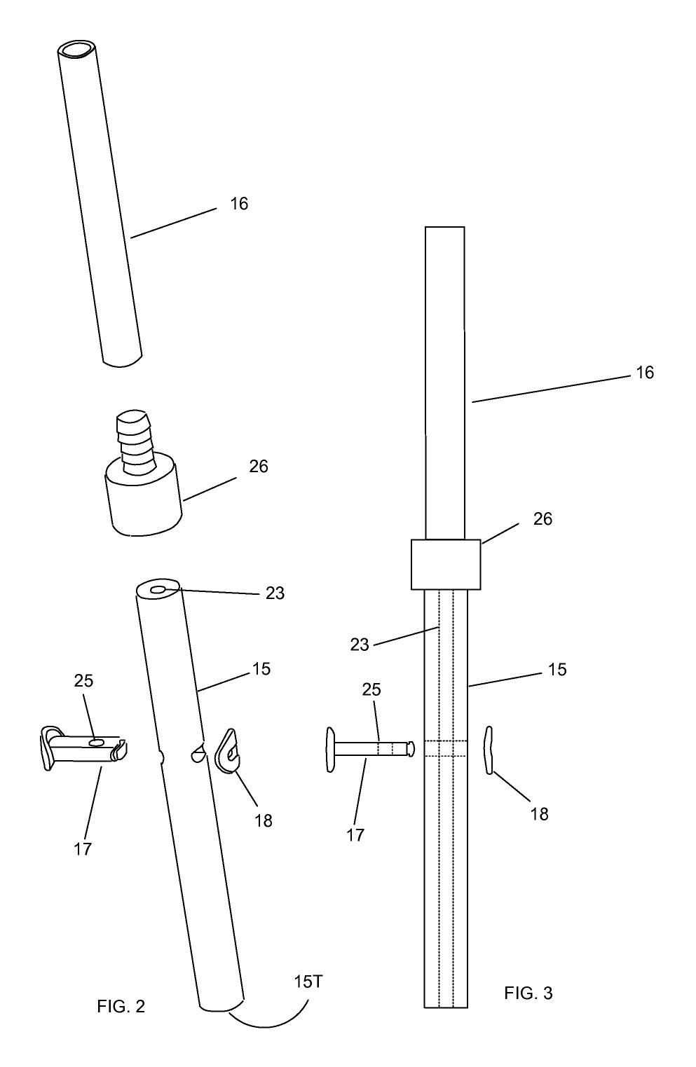

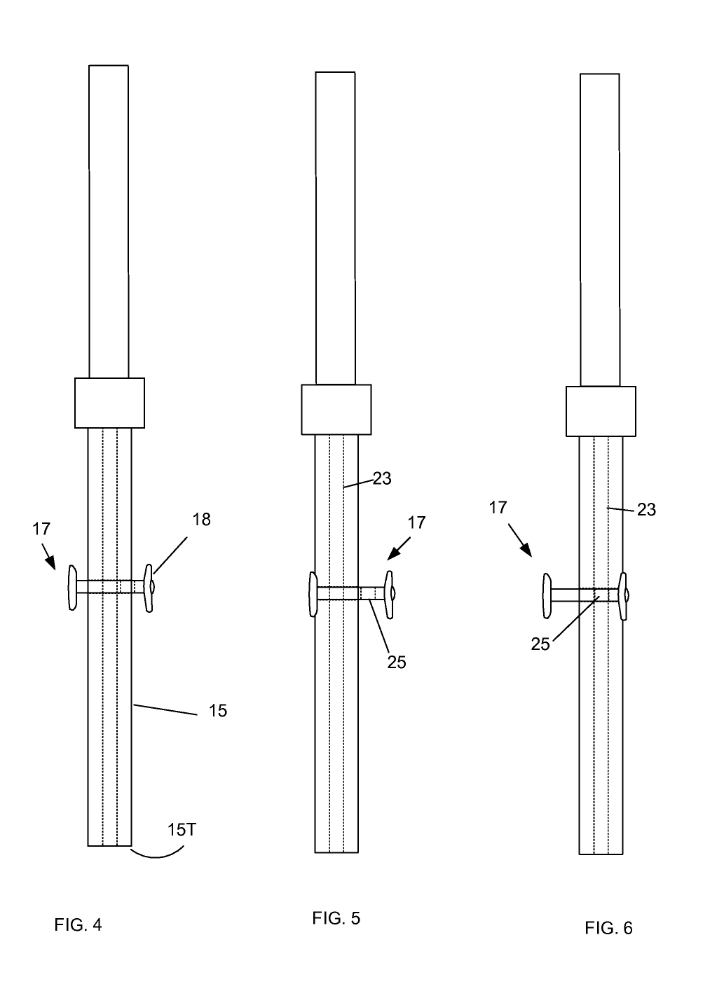

FIG. 2 shows an exploded perspective view and FIG. 3 shows a side view of preferred saliva ejector 15 and tubing 16. Saliva injector 15 includes hollow bore 23. Push valve 17 connects to retaining clip 18 (see also FIG. 4). Push valve 17 includes bore 25. Tube connector 26 press fits onto saliva ejector 15 and onto flexible tube 16. Preferably saliva ejector 15 is fabricated from non-latex plastic.

### Operation of Saliva Ejector

To operate saliva ejector 15, the dental practitioner first turns on vacuum pump 24 (FIG. 7).

In FIG. 5 the dental practitioner has pushed valve 17 to the right to turn it off. Bore 25 is not aligned with bore 23. Therefore there is no vacuum suction at the top of saliva ejector 15.

In FIG. 6 the dental practitioner has pushed valve 17 to the left to turn it on. Bore 25 is now aligned with bore 23. Therefore there is vacuum suction at the top of saliva ejector 15. Saliva ejector 15 can now be used to remove saliva from the mouth of the patient.

It should be noted that because valve 17 is located away from tip 15T of saliva ejector 15, valve 17 does not get inserted into the mouth of the patient. This allows valve 17 to be turned on or off while the saliva ejector remains in the mouth of the patient. Also, because saliva ejector valve 17 is a push valve, it can easily be operated with only one hand of the dental practitioner. This allows the dental practitioner to control saliva ejector 15 with one hand while holding or operating another dental tool with his other hand.

### Other Preferred Embodiment

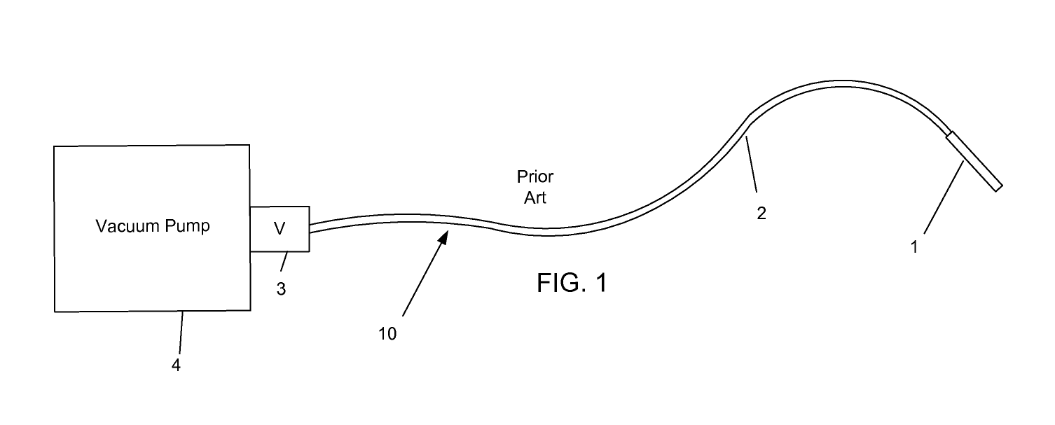

FIG. 8 shows another preferred embodiment of the present invention. In FIG. 8 tube 16 is connected to prior art on/off valve 3 as in FIG. 1. In the preferred embodiment shown in FIG. 8, tube 16 and saliva ejector 15 are utilized with a prior art vacuum pump 4 and valve 3. In this preferred embodiment. Valve 3 is always kept open to minimize contamination of the valve. The vacuum on and off is controlled via valve 17 (as described above.)

### High Volume Suction Evacuator

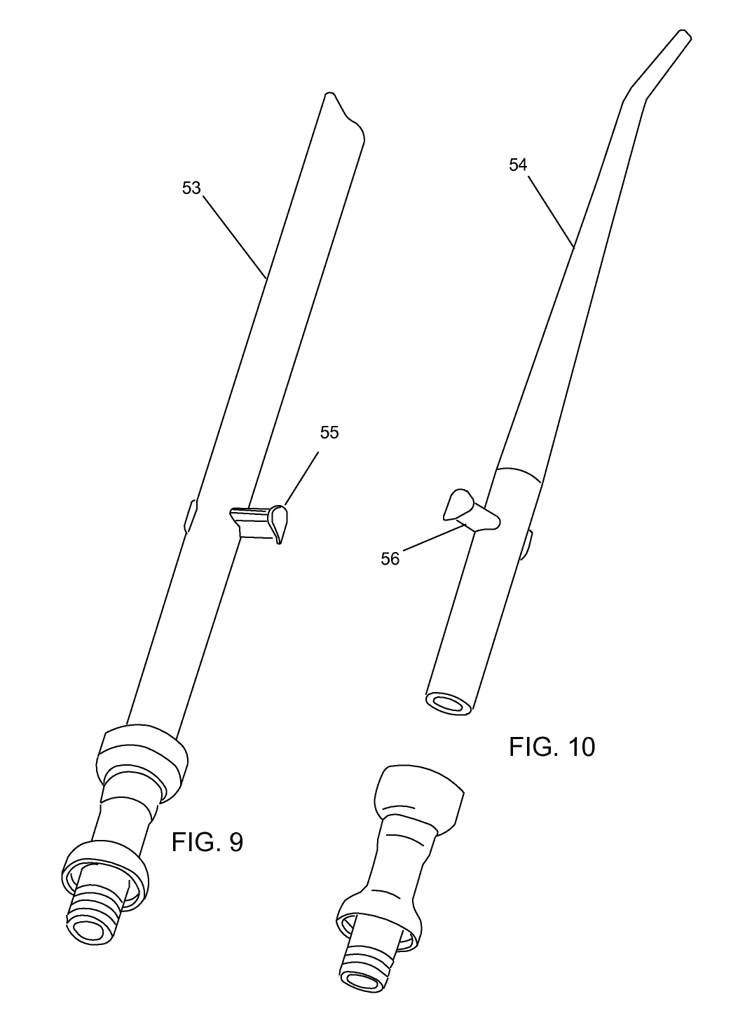

FIG. 9 shows tip 53 for a high volume suction evacuator system. Tip 53 includes push valve 55. As with the tip 15 discussed above, tip 53 is disposable so that tip 53 can be replaced as appropriate between patients.

### Surgical High Volume Suction Evacuator

FIG. 9 shows tip 54 for a surgical high volume suction evacuator system. Tip 54 includes push valve 56. As with the tip 15 discussed above, tip 54 is disposable so that tip 53 can be replaced as appropriate between patients.

Although the above-preferred embodiments have been described with specificity, persons skilled in this art will recognize that many changes to the specific embodiments disclosed above could be made without departing from the spirit of the invention. For example, although FIGS. 2-6 show the operation of push valve 17, it is possible to substitute various other on/off valve types (including valves having a lever or a knob control) for controlling the vacuum. Also, although it was stated that preferably tubing 16 and saliva ejector 15 are both discarded after use on a patient, it is possible to discard only saliva ejector 15 and retain tubing 16 for multiple patients. Tubing 16 would be sanitized between each patient. Therefore, the attached claims and their legal equivalents should determine the scope of the invention.

1. A system for removing saliva or debris from the mouth of a dental patient, said system comprising:
A. a vacuum pump,
B. tubing connected to said vacuum pump,
C. a tip removably connected to said tubing,
D. a vacuum control valve connected to said removably connected tip, wherein said vacuum control valve is positioned so that said vacuum control valve remains outside of the patient's mouth when said removably connected tip is inserted into the patient's mouth.

2. The system as in claim 1 wherein said tip is a saliva ejector tip.

3. The system as in claim 1 wherein said tip is a high volume suction evacuator tip.

4. The system as in claim 1 wherein said tip is a surgical high volume suction evacuator tip.

5. The system as in claim 1 wherein said vacuum control valve is a push valve.

6. The system as in claim 1 wherein said push valve is a single hand operated push valve.

7. The system as in claim 1, wherein said vacuum control valve is positioned along the length of said tip.

8. A system for removing saliva from the mouth of a dental patient, said saliva ejector system comprising:
A. a vacuum pump means for providing a vacuum,
B. a tubing means for allowing for debris and air flow, said tubing means connected to said vacuum pump means,
C. a tip means for insertion into the dental patient's mouth, said tip means removably connected to said tubing means,
D. a vacuum control valve means for controlling vacuum, said vacuum control valve means connected to said removably connected tip means, wherein said vacuum control valve means is positioned so that said vacuum control valve means remains outside of the patient's mouth when said removably connected tip means is inserted into the patient's mouth.

9. The system as in claim 8 wherein said vacuum control valve means is a push valve.

10. The system as in claim 8 wherein said push valve is a single hand operated push valve.

11. The system as in claim 8, wherein said vacuum control valve means is positioned along the length of said tip means.

12. The system as in claim 1, wherein said tubing and said tip are disposed of between each patient.

13. A method for removing saliva or debris from the mouth of a dental patient, said method comprising the steps of:
A. utilizing a system to remove the saliva and debris from the mouth of the dental patient, said system comprising:
1. a vacuum pump,
2. tubing connected to said vacuum pump,
3. a tip removably connected to said tubing,
4. a vacuum control valve connected to said removably connected tip, wherein said vacuum control valve is positioned so that said vacuum control valve remains outside of the patient's mouth when said removably connected tip is inserted into the patient's mouth,
B. disposing of said tubing and said tip, and
C. connecting a new tubing and a new tip to said system in preparation for a next patient.
